(19) United States
(12) Patent Application Publication
(10) Pub. No.: US 2026/0361788 A1
(43) Pub. Date: Nov. 12, 2026

(54) Remote Direct Memory Access Single-Signal Transfer with Parallel Asynchronous Chunking

(71) Applicant: Dell Products L.P., Round Rock, TX (US)

(72) Inventors: Jason Goldschmidt, Newton, MA (US); Michael Marrotte, Orlando, FL (US); John P. Marchese, JR., East Hampton, CT (US)

(21) Appl. No.: 19/202,863

(22) Filed: May 8, 2025

(51) Int. Cl. H04L 67/1097; G06F 12/02

(52) U.S. Cl. CPC H04L 67/1097; G06F 12/0223; G06F 2212/1016

(57) ABSTRACT

A system can receive a PUT object operation instruction from an object storage client that indicates an object, wherein the object storage client stores the object in a memory of the object storage client. The system can, based on the receiving of the PUT object operation instruction, perform respective asynchronous remote direct memory access read operations on respective chunks of the memory of the object storage client. The system can store respective results of the respective asynchronous remote direct memory access read operations into respective buffers of an array of buffers.

### BACKGROUND

An object storage system can store computer data as objects in a flat storage space, where an object can be identified by a bucket and an identifier of the object within the bucket. Object storage can be viewed in contrast to file storage, where data is stored as files in a hierarchical ordering of directories. Remote direct memory access (RDMA) generally comprises an approach for one computer to access the memory of another computer, such as to read from that memory or to write to that memory.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a PUT object operation instruction from an object storage client that indicates an object, wherein the object storage client stores the object in a memory of the object storage client. The system can, based on the receiving of the PUT object operation instruction, perform respective asynchronous remote direct memory access read operations on respective chunks of the memory of the object storage client. The system can store respective results of the respective asynchronous remote direct memory access read operations into respective buffers of an array of buffers.

An example method can comprise, based on receiving a PUT object operation instruction from an object storage client that indicates an object, wherein the object storage client stores the object in a memory of the object storage client, performing, by a system comprising at least one processor, respective asynchronous remote direct memory access read operations on respective chunks of the memory of the object storage client. The method can further comprise storing, by the system, respective results of the respective asynchronous remote direct memory access read operations into respective buffers of an array of buffers.

An example non-transitory computer-readable medium can comprise instructions that, in response to execution, cause a system comprising a processor to perform operations. These operations can comprise, based on receiving a PUT object operation instruction from an object storage client that indicates an object, wherein the object storage client stores the object in a memory of the object storage client, performing respective asynchronous remote direct memory access read operations on respective chunks of the memory of the object storage client. These operations can further comprise storing respective results of the respective asynchronous remote direct memory access read operations into respective buffers of an array of buffers.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate RDMA single-signal transfer with parallel asynchronous chunking, in accordance with an embodiment of this disclosure;

FIG. 2 illustrates another example system architecture that can facilitate RDMA single-signal transfer with parallel asynchronous chunking, in accordance with an embodiment of this disclosure;

FIG. 3 illustrates an example signal flow that can facilitate RDMA single-signal transfer with parallel asynchronous chunking, in accordance with an embodiment of this disclosure;

FIG. 4 illustrates an example process flow that can facilitate RDMA single-signal transfer with parallel asynchronous chunking, in accordance with an embodiment of this disclosure;

FIG. 5 illustrates another example process flow that can facilitate RDMA single-signal transfer with parallel asynchronous chunking, in accordance with an embodiment of this disclosure;

FIG. 6 illustrates another example process flow that can facilitate RDMA single-signal transfer with parallel asynchronous chunking, in accordance with an embodiment of this disclosure;

FIG. 7 illustrates another example process flow that can facilitate RDMA single-signal transfer with parallel asynchronous chunking, in accordance with an embodiment of this disclosure;

FIG. 8 illustrates another example process flow that can facilitate RDMA single-signal transfer with parallel asynchronous chunking, in accordance with an embodiment of this disclosure;

FIG. 9 illustrates another example process flow that can facilitate RDMA single-signal transfer with parallel asynchronous chunking, in accordance with an embodiment of this disclosure;

FIG. 10 illustrates an example process flow that can facilitate RDMA single-signal transfer with parallel asynchronous chunking, in accordance with an embodiment of this disclosure; and

FIG. 11 illustrates an example block diagram of a computer operable to execute an embodiment of this disclosure.

### DETAILED DESCRIPTION

### OVERVIEW

Prior approaches for transferring object data using an object storage protocol can be limited in performance due to the speed and limitations of Hypertext Transfer Protocol (HTTP) and Hypertext Transfer Protocol Secure (HTTPS). In addition, object storage protocol data transfers can rely on traversing the central processing unit (CPU), and can place additional unnecessary load on the system. There can be an opportunity for a more performant and efficient approach to transferring data using an object storage protocol.

The present techniques can utilize a remote direct memory access (RDMA), which can facilitate direct memory access from the memory of one computer into that of another without involving either computer's operating system. This can enable high-throughput, low-latency networking, which can be useful in environments like massively parallel computer clusters. RDMA can support zero-copy networking by enabling the network adapter to transfer data directly to or from application memory, bypassing the CPU and operating system.

The present techniques can facilitate transferring large data objects to an object storage protocol bucket using remote direct memory access (RDMA), initiated by a single client signal. An object storage protocol server can manage the transfer process, executing parallel asynchronous RDMA READ operations to retrieve the object from the client’s memory, and applying backend chunking logic to optimize storage writes. This approach can eliminate additional client-server signaling beyond the initial request and response, targeting higher throughput and lower latency compared to prior approaches using an object storage protocol multipart upload (MPU).

An example system according to the present techniques is engineered to leverage RDMA for accelerated data transfers in high-bandwidth, stable network environments. RDMA can enable direct memory-to-memory data movement between a client and a server without CPU involvement, utilizing RDMA-capable network interface controllers (NICs). Features of RDMA can include:
Single signal initiation: The client can transmit one HTTP PUT request to an object storage protocol endpoint, including the object key and an x-rdma-info header containing values for size and RDMA address, after which the object storage protocol server can assume full control of the transfer.
Server-driven RDMA: An object storage protocol server can initiate and manage RDMA READ operations to pull the object from the client’s pre-registered memory region.
Parallel asynchronous execution: Multiple RDMA READs can be issued concurrently and processed asynchronously, allowing out-of-order data arrival to be handled efficiently. Asynchronous processing can refer to operations completing independently of their initiation order, managed by server-side threads. In some examples, these threads can exist outside of a RDMA process that performs a RDMA read, and can monitor whether the RDMA processes have completed reading respective chunks.
Backend chunking: The server can divide incoming data into chunks optimized for the storage backend. These chunks can be written using an IOVECTOR mechanism, where an IOVECTOR is a data structure (e.g., an array of buffers) enabling scatter-gather I/O operations to write multiple non-contiguous memory segments in a single system call. Chunk sizes can be implementation-dependent and tailored to backend requirements. An IOVECTOR write can comprise writing multiple separate memory buffers to a file with one API call. That is, rather than joining the data into one buffer first, each piece of data can be pointed to, and a system can write them in order. In some examples, the IOVECTOR writes can begin before all RDMA READs have completed (e.g., the IOVECTOR writes for one fully-read chunk can be initiated even though there are other chunks that are not yet fully read). In other examples, IOVECTOR writes begin after all chunks have been read via RDMA READs.

This design can contrast with an object storage protocol MPU, which can rely on multiple HTTP requests and client-side coordination for large object uploads.

Consider the following example, which is illustrative of performance of according to the present techniques. A 10 gigabyte (GB) object (10,737,418,240 bytes) is transferred over a 100 gigabits-per-second (Gbps) network. Specific values below can be examples for illustration, based on prototyping parameters such as an Ethernet maximum transmission unit (MTU) of 9,000 bytes (jumbo frames) and a RDMA frame size of 4,096 bytes.
Initial signal: A client sends a HTTP PUT request (~1 millisecond (ms) latency, on a 100 Gbps local area network (LAN)). Example: PUT https://bucket.objectstorage.domain.tld/bigfile.dat, Content-Length: 0, x-rdma-info with values such as 10737418240:[client RDMA address].
RDMA transfer: The server issues multiple parallel RDMA READs (e.g., 16 READs, each 16 MB or 671,088,640 bytes). Total chunks: 16 (with the last chunk ~9 MB, as an example).
Packets per chunk: 16 MB ÷ 4,096-byte RDMA frame size = 4,096 RDMA packets; total = 65,536 RDMA packets (example based on 4,096-byte RDMA frame size). With an Ethernet MTU of 9,000 bytes, approximately two RDMA frames fit per Ethernet frame (e.g., ~7,479 Ethernet packets per 16 MB chunk, after headers).
Transfer time: 16 MB ÷ 12.5 GB/s (100 Gbps) = 1.28 ms/chunk; 16 READs in one wave = ~2.3 ms including setup overhead (example estimate).
Backend writes: Each chunk splits into smaller segments (e.g., 16 MB into 16 x 1 MB IOVECTORS). solid state drive (SSD) write speed of 1 GB/s yields 1 ms per 1 MB; 16 ms/chunk, pipelined across 16 chunks = ~16 ms total (example based on 1 GB/s SSD). Chunk size can be selected to align with storage backend storage parameters.
Response: The server sends a HTTP 200 OK (~1 ms assumed).
Estimated total time: 2.3 ms (transfer) + 16 ms (write) + 1 ms (response) = ~19.3 ms (ideal case; ~25 ms with minor packet loss retries, as an example).

In contrast to this above example, consider another example of transferring the same data according to prior approaches. Again, to evaluate performance, consider a 10 GB object (10,737,418,240 bytes) transferred over a 100 Gbps network. Specific values below can be examples for illustration, based on prototyping parameters such as an Ethernet MTU of 9,000 bytes (jumbo frames) and an RDMA frame size of 4,096 bytes.
Initiation: The client sends a CreateMultipartUpload (~1 ms latency on a 100 Gbps LAN). Upload parts: 10 GB / 64 MB = 160 parts (67,108,864 bytes each, as an example part size).
Each UploadPart request: ~1.5 ms (latency + upload at 100 Gbps, example estimate). 16 threads: 160 parts / 16 = 10 waves; 10 * 1.5 ms = 15 ms (example threading configuration).
Backend writes: Server processes 64 MB parts into smaller segments (e.g., 64 * 1 MB IOVECTORS, ~64 ms pipelined as an example).
Completion: CompleteMultipartUpload (~1 ms assumed).
Estimated total time: 1 ms (init) + 15 ms (upload) + 64 ms (write) + 1 ms (complete) = ~81 ms (LAN example at 100 Gbps).

A performance comparison between these two examples – one according to the present techniques and another according to prior approaches) is as follows:
Latency: an object storage protocol RDMA targets ~19-25 ms vs. MPU’s ~81 ms—a 3-4x reduction (example based on above conditions).
Signaling overhead: One HTTP PUT vs. 162 requests (init + 160 parts + complete, as an example).
Resource usage: RDMA offloads to NIC hardware vs. MPU’s reliance on client-side CPU and threading.

Technical advantages of the present techniques compared to prior approaches are as follows:
Throughput and latency: The present techniques can obtain transfer times significantly lower than MPU by utilizing RDMA’s zero-copy capabilities and minimizing (or reducing) signaling.
Server control: Transfer logic can reside on the object storage protocol server, reducing client complexity compared to MPU’s multi-threaded requirements.
Storage integration: Backend chunking can align data with storage systems using IOVECTORS, minimizing post-transfer processing overhead present in some MPU implementations.
Workflow efficiency: The single-signal approach can reduce operational steps compared to MPU’s multi-phase process.

A system according to the present techniques is designed for high-bandwidth, low-latency environments (e.g., 100 Gbps data center networks) where rapid large-object uploads can be required, such as machine learning (ML) dataset transfers or real-time data ingestion. It can also support GPU-centric applications, enabling direct uploads from GPU memory for AI workloads using technologies like GPUDirect, which bypasses CPU involvement—unlike prior approaches to an object storage protocol MPU, which lacks such direct memory access capabilities.

In some examples, implementation considerations can be as follows:
Hardware requirements: It can be that both client and server support RDMA-capable NICs.
Memory constraints: It can be that the client’s registered memory region accommodates the entire object. For context, prior approaches for an object storage protocol single PutObject can limit uploads to 5 GiB (5,368,709,120 bytes) as an example.
Backend limits: Storage write speed can constrain throughput where slower than the RDMA transfer rate.

The present techniques can facilitate an object storage protocol RDMA single-signal transfer with parallel asynchronous chunking that is an offload designed system offering a high-performance alternative to prior approaches for an object storage protocol MPU for large object uploads. By leveraging a single HTTP PUT request with an x-rdma-info header containing size and RDMA address (for example, there can be other examples with different format implementations), server-initiated RDMA READs, and backend-optimized chunking with IOVECTORS, the present techniques can facilitate significantly lower latency (e.g., 19-25 ms vs. 81 ms for 10 GB as an example) and reduced overhead relative to prior approaches. This approach can be tailored for environments prioritizing speed and efficiency over mid-transfer retry capabilities.

The present techniques can provide increased throughput, reduced latency, and eliminate CPU overhead for transferring data using an object storage protocol. They can use single signal initiation, server drive RDMA, parallel asynchronous execution, and backend chunking. The present techniques can provide a more efficient use of resources for both the client and storage server. The present techniques can accelerate storage performance for several workloads including artificial intelligence (AI), high performance computing (HPC), and GPU -centric applications.

The present techniques can increase end to end throughput and reduce latency between clients and storage products. The present techniques can enhance performance for AI workloads with being able to write directly to memory between a client and storage products. The present techniques can be used with GPU clients to enable direct uploads from GPU memory.

The present techniques can enable an object storage protocol server to autonomously manage a high-speed, large-object RDMA transfer and backend chunking using a single client HTTP PUT request, eliminating the need for multiple signals or client-side coordination that can be required by prior approaches for an object storage protocol Multipart Upload.

The present techniques can utilize HTTP/HTTPS to transfer the data using an object storage protocol. The performance limitations of a transmission control protocol (TCP) approach can come into play, and it can be that hardware offloading is not an available option, creating more overhead on the CPU of the client and storage endpoint.

### EXAMPLE ARCHTECTURES, ETC

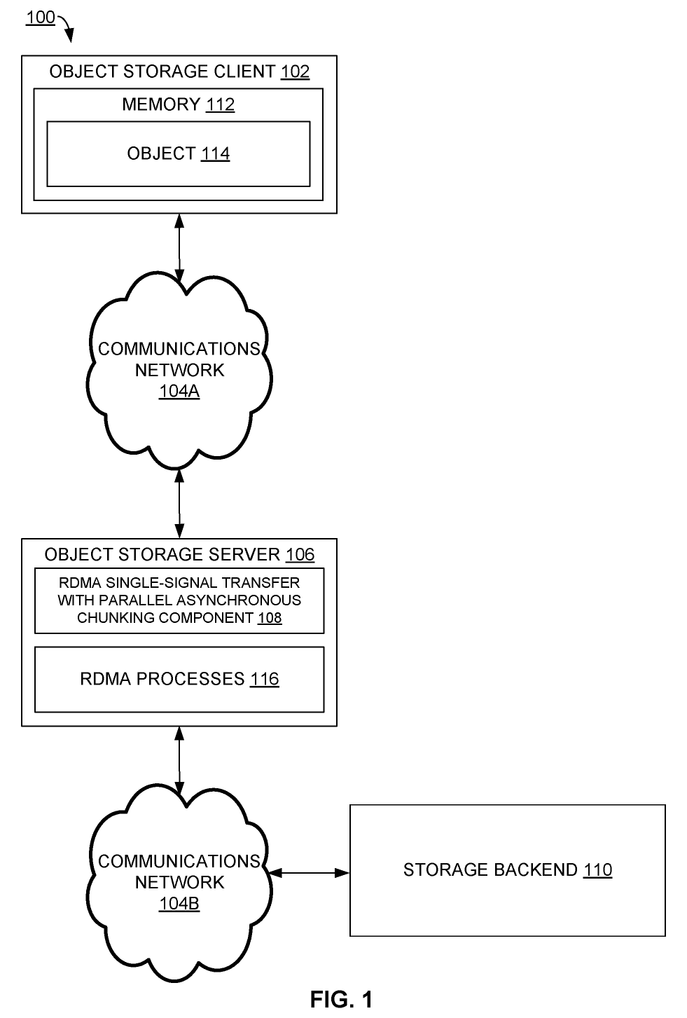

FIG. 1 illustrates an example system architecture 100 that can facilitate RDMA single-signal transfer with parallel asynchronous chunking, in accordance with an embodiment of this disclosure.

System architecture 100 comprises object storage client 102, communications network 104A, communications network 104B, object storage server 106, and storage backend 110. In turn, object storage client 102 comprises memory 112 and object 114; and object storage server 106 comprises RDMA single-signal transfer with parallel asynchronous chunking component 108, and RDMA processes 116.

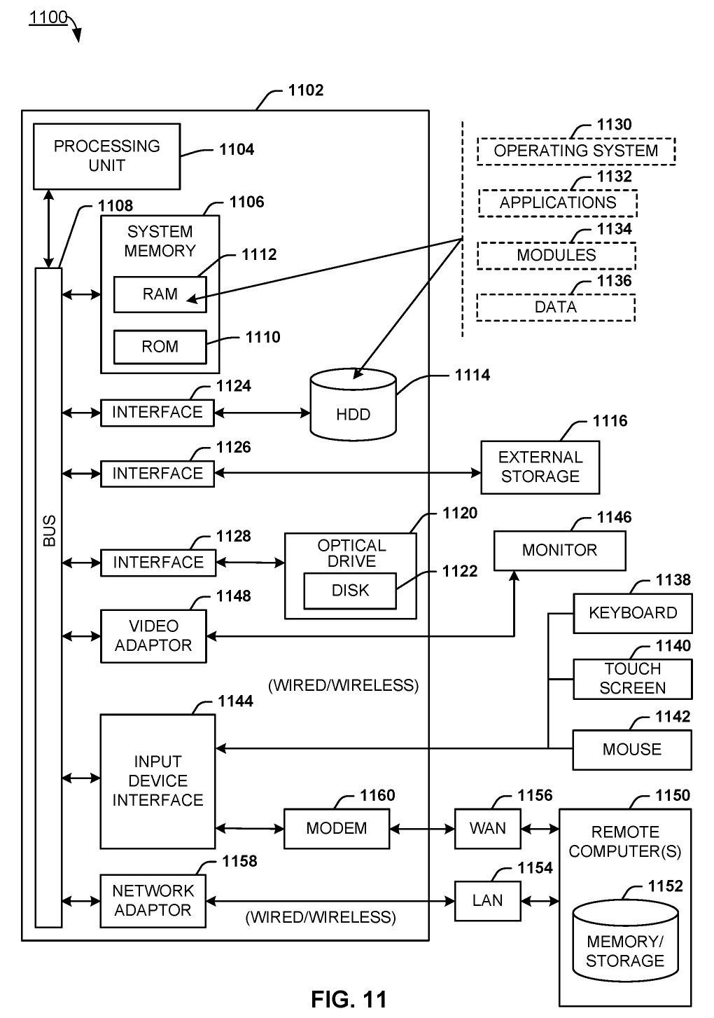

Each of object storage client 102, object storage server 106, and/or storage backend 110 can be implemented with part(s) of computing environment 1100 of FIG. 11. Each of communications network 104A and communications network 104B can comprise a computer communications network, such as the Internet.

Object storage client 102 can send a PutObject message to object storage server 106 via communications network 104A, to transfer object 114 as stored in memory 112. In response to this, object storage server 106 can initiate multiple parallel and asynchronous RDMA processes (via RDMA processes 116) to read separate portions of object 114. Object storage server 106 can then store the read object in storage backend 110 via communications network 104B (such as via IOVECTOR write operations).

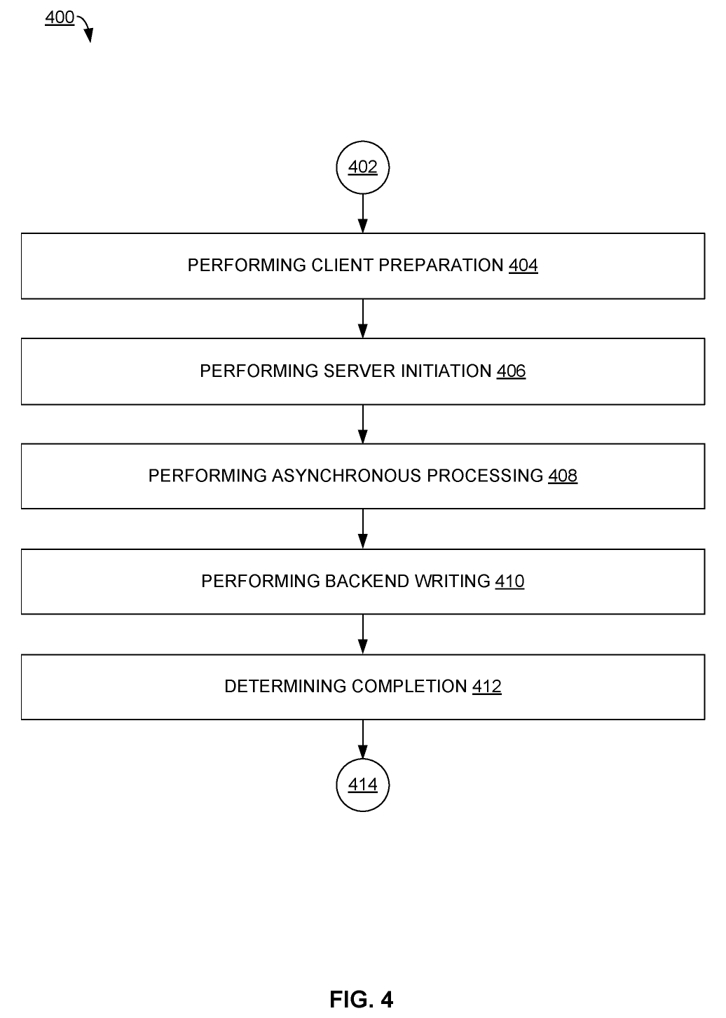

In some examples, RDMA single-signal transfer with parallel asynchronous chunking component 108 can implement part(s) of the process flows of FIGS. 4-10 to implement RDMA single-signal transfer with parallel asynchronous chunking.

It can be appreciated that system architecture 100 is one example system architecture for RDMA single-signal transfer with parallel asynchronous chunking, and that there can be other system architectures that facilitate RDMA single-signal transfer with parallel asynchronous chunking.

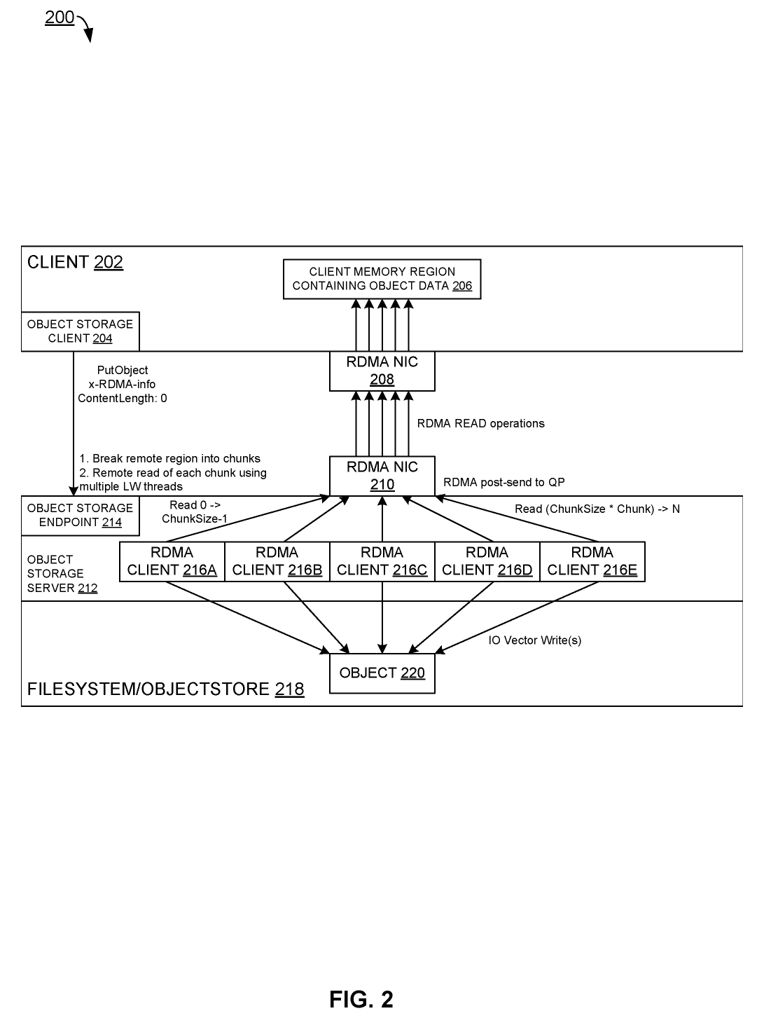

FIG. 2 illustrates another example system architecture 200 that can facilitate RDMA single-signal transfer with parallel asynchronous chunking, in accordance with an embodiment of this disclosure. In some examples, part(s) of system architecture 200 can be used by part(s) of system architecture 100 of FIG. 1 to facilitate RDMA single-signal transfer with parallel asynchronous chunking.

System architecture 200 comprises client 202, object storage client 204, client memory region containing object data 206, RDMA NIC 208, RDMA NIC 210, object storage server 212, object storage endpoint 214, RDMA client 216A, RDMA client 216B, RDMA client 216C, RDMA client 216D, RDMA client 216E, filesystem/ObjectStore 218, and object 220.

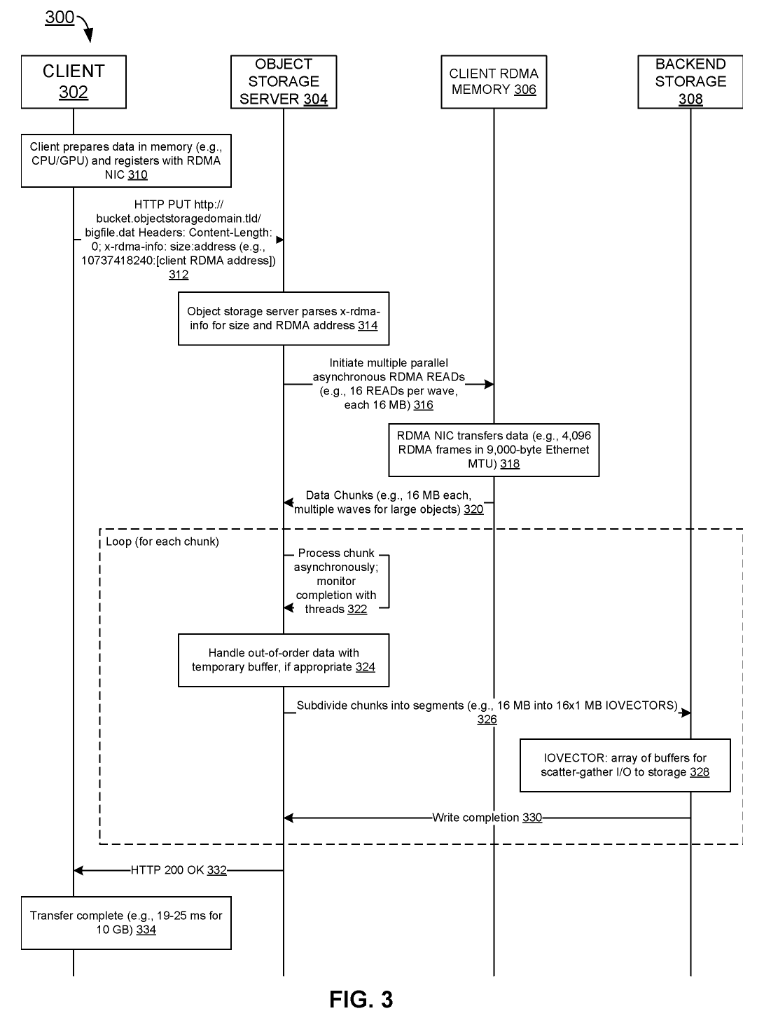

FIG. 3 illustrates an example signal flow 300 that can facilitate RDMA single-signal transfer with parallel asynchronous chunking, in accordance with an embodiment of this disclosure. In some examples, part(s) of signal flow 300 can be used by part(s) of system architecture 100 of FIG. 1 to facilitate RDMA single-signal transfer with parallel asynchronous chunking.

Signal flow 300 comprises signals sent between client 302, object storage server 304, client RDMA memory 306, and backend storage 308.

Signals and operations of signal flow 300 are:
Client prepares data in memory (e.g., CPU/GPU) and registers with RDMA NIC 310;
HTTP PUT http://bucket.objectstoragedomain.tld/bigfile.dat; Headers: Content-Length: 0; x-rdma-info: size:address (e.g., 10737418240:[client RDMA address]) 312;
Object storage server parses x-rdma-info for size and RDMA address 314;
Initiate multiple parallel asynchronous RDMA READs (e.g., 16 READs per wave, each 16 MB) 316;
RDMA NIC transfers data (e.g., 4,096 RDMA frames in 9,000-byte Ethernet MTU) 318;
Data Chunks (e.g., 16 MB each, multiple waves for large objects) 320;
Process chunk asynchronously; monitor completion with threads 322;
Handle out-of-order data with temporary buffer, if appropriate 324;
Subdivide chunks into segments (e.g., 16 MB into 16x1 MB IOVECTORS) 326;
IOVECTOR: array of buffers for scatter-gather I/O to storage 328;
Write completion 330;
HTTP 200 OK 332; and
Transfer complete (e.g., 19-25 ms for 10 GB) 334.

### EXAMPLE PROCESS FLOWS

FIG. 4 illustrates an example process flow 400 that can facilitate RDMA single-signal transfer with parallel asynchronous chunking, in accordance with an embodiment of this disclosure. In some examples, one or more embodiments of process flow 400 can be implemented by RDMA single-signal transfer with parallel asynchronous chunking component 108 of FIG. 1, or computing environment 1100 of FIG. 11.

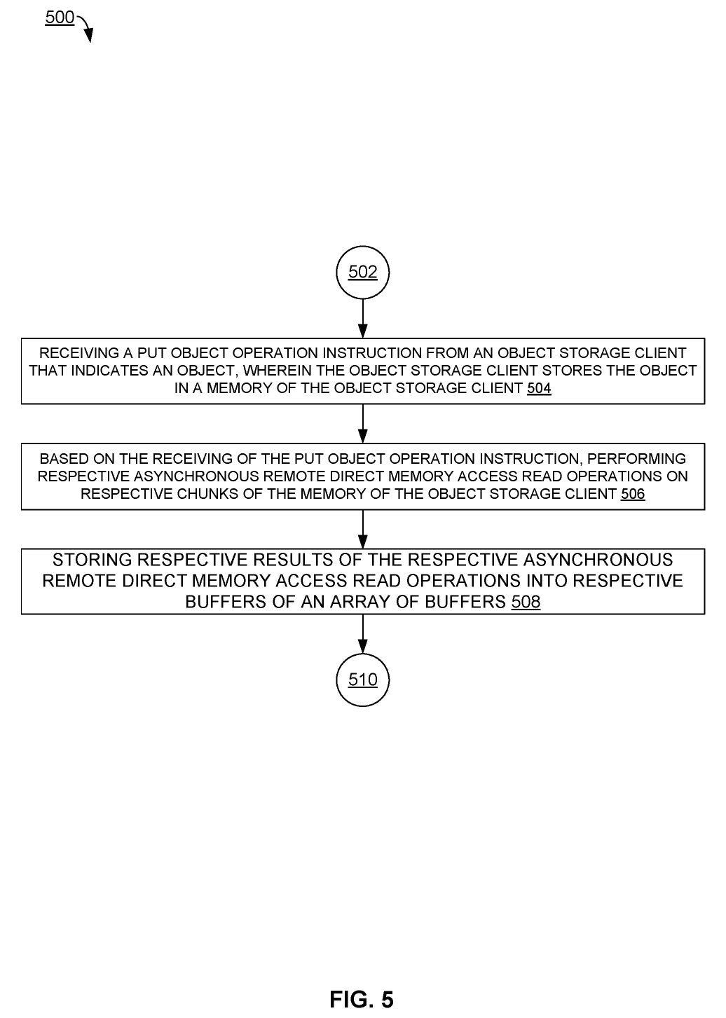

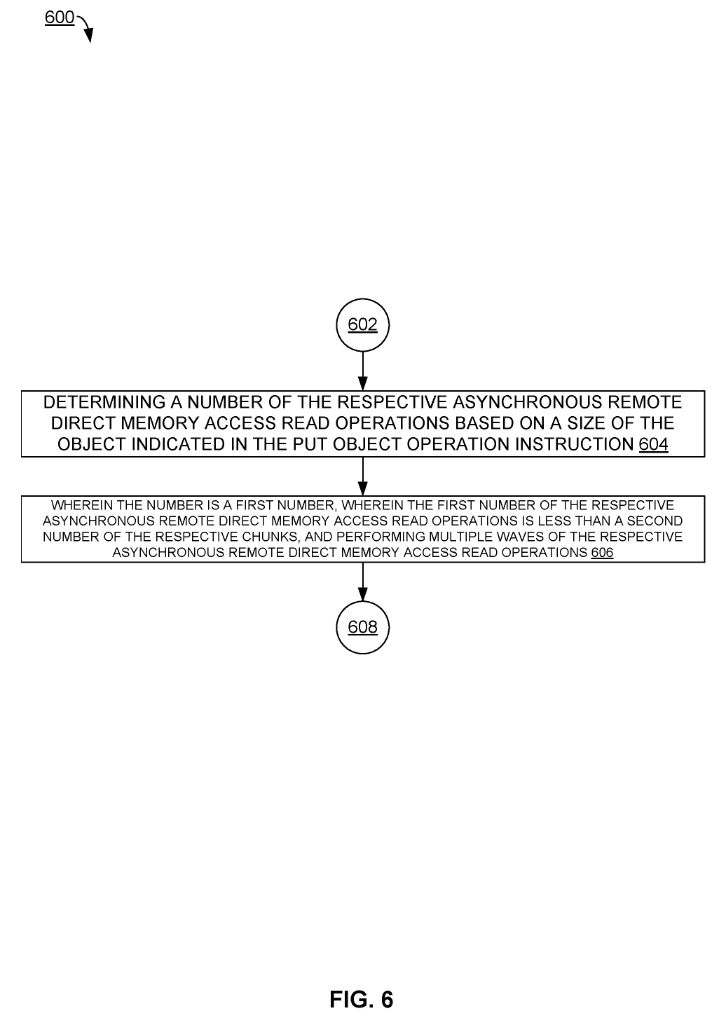

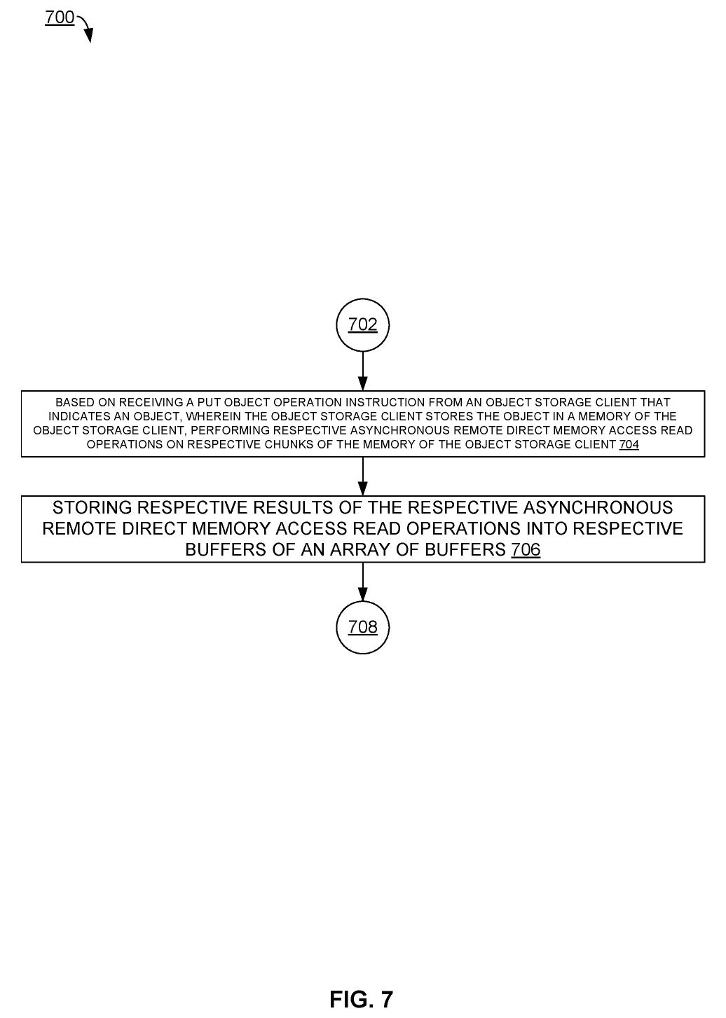

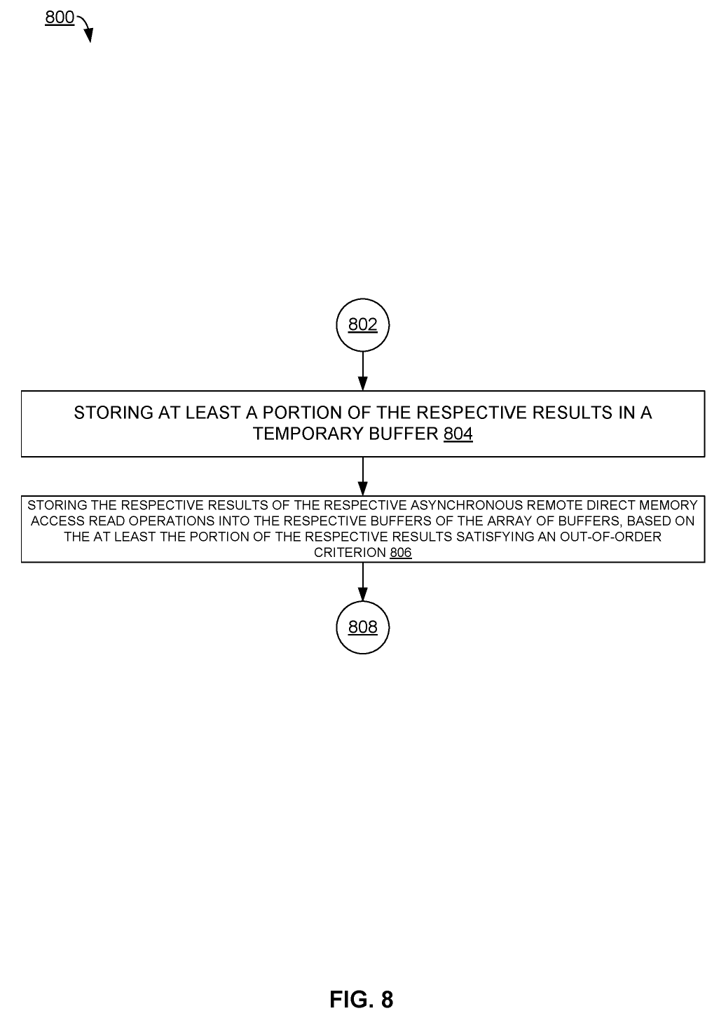

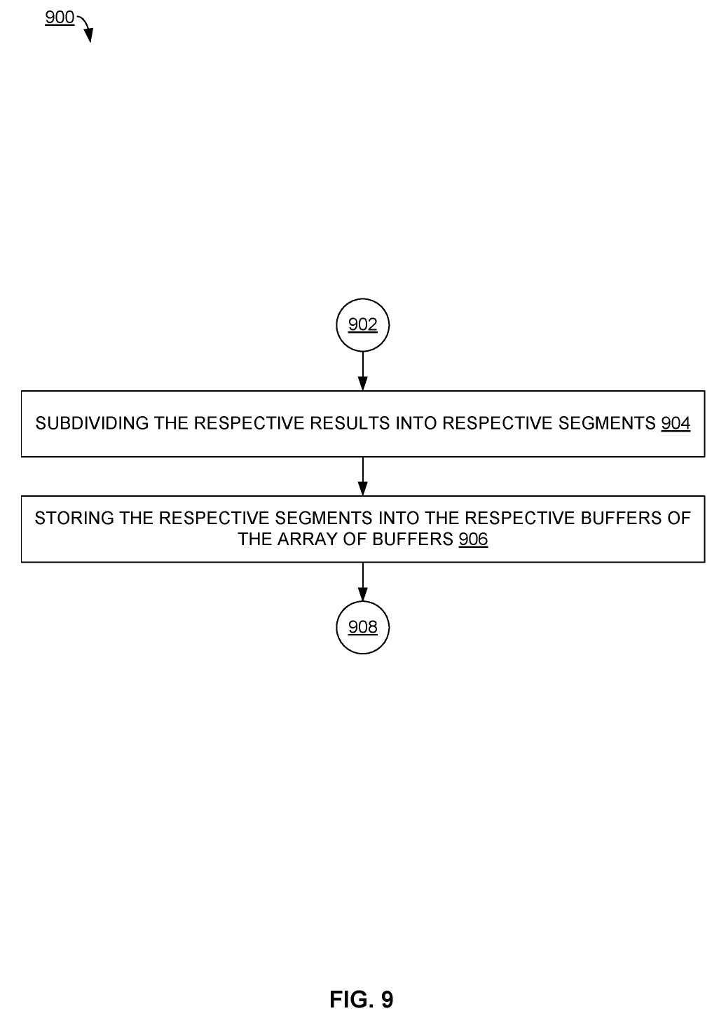

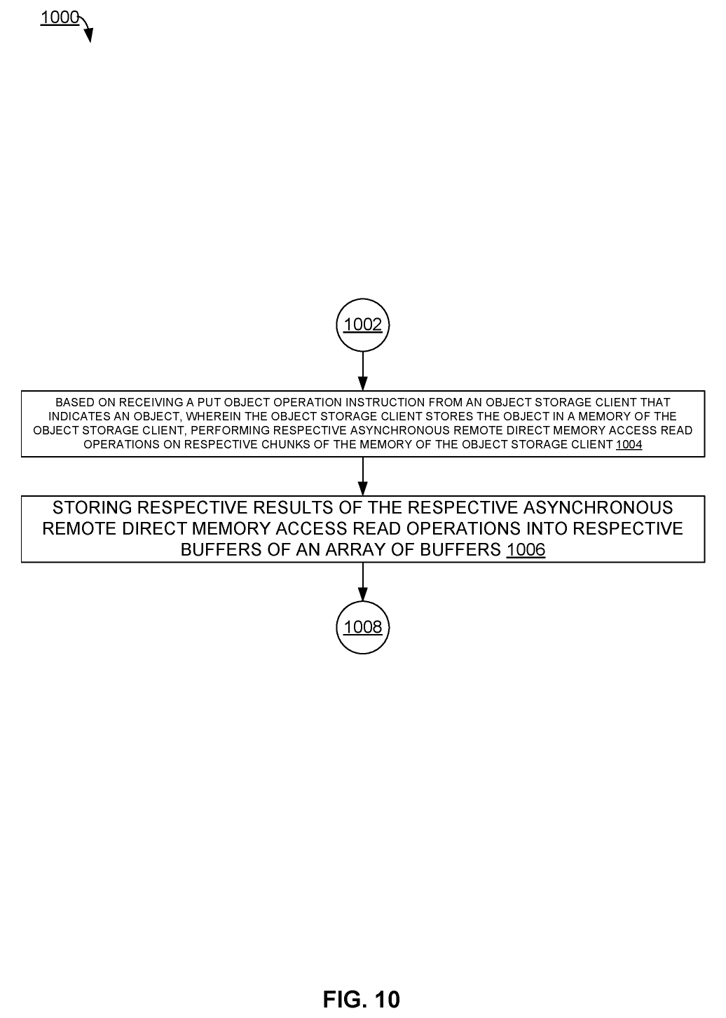

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts performing client preparation. In some examples, the client prepares the data object in memory (e.g., CPU or graphics processing unit (GPU)), registers it with the RDMA NIC, and sends a single HTTP PUT request to the object storage protocol server. Example: PUT https://bucket.objectstorage.domain.tld/bigfile.dat with headers Content-Length: 0 and x-rdma-info containing size and RDMA address (e.g., 10737418240:[client RDMA address]).

After operation 404, process flow 400 moves to operation 406.

Operation 406 depicts performing server initiation. In some examples, the object storage protocol server receives the request, parses the x-rdma-info header for size and RDMA address, and initiates multiple RDMA READ operations to retrieve the object from the client’s memory. For example, a set of parallel READs can be issued, each targeting a chunk (e.g., 16 megabytes (MB)).

After operation 406, process flow 400 moves to operation 408.

Operation 408 depicts performing asynchronous processing. In some examples, each RDMA READ operates independently, with completion monitored by separate server threads. Out-of-order data can be accommodated using a temporary buffer, in some examples.

After operation 408, process flow 400 moves to operation 410.

Operation 410 depicts performing backend writing. In some examples, the server processes each received chunk, subdividing it into smaller segments (e.g., 1 MB) for IOVECTOR writes to the storage system. The IOVECTOR structure can specify the memory locations and lengths of these segments, enabling efficient disk I/O. Segment size can be determined by backend requirements.

After operation 410, process flow 400 moves to operation 412.

Operation 412 depicts determining completion. In some examples, all data is transferred and written, the server can send a single HTTP 200 OK or appropriate object storage protocol-compliant response to the client.

After operation 412, process flow 400 moves to 414, where process flow 400 ends.

FIG. 5 illustrates another example process flow 500 that can facilitate RDMA single-signal transfer with parallel asynchronous chunking, in accordance with an embodiment of this disclosure. In some examples, one or more embodiments of process flow 500 can be implemented by RDMA single-signal transfer with parallel asynchronous chunking component 108 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts receiving a PUT object operation instruction from an object storage client that indicates an object, wherein the object storage client stores the object in a memory of the object storage client. Using the example of FIG. 3, this can comprise object storage server 304 receiving 312 (HTTP PUT http://bucket.objectstoragedomain.tld/bigfile.dat; Headers: Content-Length: 0; x-rdma-info: size:address (e.g., 10737418240:[client RDMA address]) 312) from client 302, where the memory of the object storage client is client RDMA memory 306.

In some example, the PUT object operation instruction identifies an object storage bucket of the system in which to store the object. Using the example of 312 of FIG. 3 (HTTP PUT http://bucket.objectstoragedomain.tld/bigfile.dat; Headers: Content-Length: 0; x-rdma-info: size:address (e.g., 10737418240:[client RDMA address]) 312), this can be “bucket.objectstoragedomain.tld” that identifies the bucket on the server.

In some examples, the PUT object operation instruction identifies an address of the memory and a size of the object. Using the example of 312 of FIG. 3, this can be “size:address (e.g., 10737418240:[client RDMA address]),” where “10737418240” is the size of the object, and “[client RDMA address]” identifies the address of the memory.

In some examples, an x-rdma-info header of the PUT object operation instruction identifies the address of the memory and the size of the object. Using the example of 312 of FIG. 3, this can be “x-rdma-info: …” identifying this information.

In some examples, the PUT object operation instruction is received according to a hypertext transfer protocol. Using the example of 312 of FIG. 3, “http” of “http://bucket.objectstoragedomain.tld/bigfile.dat” can identify that a Hypertext Transfer Protocol is being used (in some examples, HTTPS can be used).

In some examples, the PUT object operation instruction identifies a content length associated with the PUT object operation instruction as being equal to zero. Using the example of 312 of FIG. 3, this can be “Content-Length: 0.” It can be that in PUT object requests where the data to be stored as an object is included with the request that this value is greater than zero (identifying a size of the object). According to the present techniques, where the object is transferred via RDMA operations, so not included directly with the PUT object request, “Content-Length: 0” can indicate that object data is not directly being included with the PUT object request.

After operation 504, process flow 500 moves to operation 506.

Operation 506 depicts, based on the receiving of the PUT object operation instruction, performing respective asynchronous remote direct memory access read operations on respective chunks of the memory of the object storage client. Continuing with the example of FIG. 3, this can be similar to 316-318 (initiate multiple parallel asynchronous RDMA READs (e.g., 16 READs per wave, each 16 MB) 316; and RDMA NIC transfers data (e.g., 4,096 RDMA frames in 9,000-byte Ethernet MTU) 318).

After operation 506, process flow 500 moves to operation 508.

Operation 508 depicts storing respective results of the respective asynchronous remote direct memory access read operations into respective buffers of an array of buffers. Continuing with the example of FIG. 3, this can be similar to 326-328 (subdivide chunks into segments (e.g., 16 MB into 16x1 MB IOVECTORS) 326; and IOVECTOR: array of buffers for scatter-gather I/O to storage 328).

After operation 508, process flow 500 moves to 510, where process flow 500 ends.

FIG. 6 illustrates another example process flow 600 that can facilitate RDMA single-signal transfer with parallel asynchronous chunking, in accordance with an embodiment of this disclosure. In some examples, one or more embodiments of process flow 600 can be implemented by RDMA single-signal transfer with parallel asynchronous chunking component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts determining a number of the respective asynchronous remote direct memory access read operations based on a size of the object indicated in the PUT object operation instruction.

After operation 604, process flow 600 moves to operation 606.

Operation 606 depicts, wherein the number is a first number, wherein the first number of the respective asynchronous remote direct memory access read operations is less than a second number of the respective chunks, and performing multiple waves of the respective asynchronous remote direct memory access read operations.

Using the example of FIG. 3, operations 604-606 can be implemented in a similar manner as 316 (Initiate multiple parallel asynchronous RDMA READs (e.g., 16 READs per wave, each 16 MB) 316).

After operation 606, process flow 600 moves to 608, where process flow 600 ends.

FIG. 7 illustrates another example process flow 700 that can facilitate RDMA single-signal transfer with parallel asynchronous chunking, in accordance with an embodiment of this disclosure. In some examples, one or more embodiments of process flow 700 can be implemented by RDMA single-signal transfer with parallel asynchronous chunking component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts, based on receiving a PUT object operation instruction from an object storage client that indicates an object, wherein the object storage client stores the object in a memory of the object storage client, performing respective asynchronous remote direct memory access read operations on respective chunks of the memory of the object storage client. In some examples, operation 704 can be implemented in a similar manner as operations 504-506 of FIG. 5.

In some examples, operation 704 comprises processing the respective chunks asynchronously. In some examples, operation 704 comprises monitoring respective completion statuses of the respective asynchronous remote direct memory access read operations with respective threads. This can be implemented in similar manner as 322 of FIG. 3 (process chunk asynchronously; monitor completion with threads 322).

After operation 704, process flow 700 moves to operation 706.

Operation 706 depicts storing respective results of the respective asynchronous remote direct memory access read operations into respective buffers of an array of buffers.

In some examples, operation 706 comprises sending the object storage client an indication that the PUT object operation instruction succeeded after the storing of the respective results of the respective asynchronous remote direct memory access read operations into the respective buffers of the array of buffers. In some examples, the indication comprises a hypertext transfer protocol message that comprises a status code that indicates that the PUT object operation instruction was completed successfully. This can be implemented in a similar manner as 330-332 of FIG. 3 (write completion 330; and HTTP 200 OK 332).

After operation 706, process flow 700 moves to 708, where process flow 700 ends.

FIG. 8 illustrates another example process flow 800 that can facilitate RDMA single-signal transfer with parallel asynchronous chunking, in accordance with an embodiment of this disclosure. In some examples, one or more embodiments of process flow 800 can be implemented by RDMA single-signal transfer with parallel asynchronous chunking component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, process flow 900 of FIG. 9, and/or process flow 1000 of FIG. 10.

In some examples, process flow 800 can be used to implement operation 706 of FIG. 7.

Process flow 800 begins with 802, and moves to operation 804.

Operation 804 depicts storing at least a portion of the respective results in a temporary buffer. Using the example of FIG. 3, this can be implemented in a similar manner as 324 (handle out-of-order data with temporary buffer, if appropriate 324).

After operation 804, process flow 800 moves to operation 806.

Operation 806 depicts storing the respective results of the respective asynchronous remote direct memory access read operations into the respective buffers of the array of buffers, based on the at least the portion of the respective results satisfying an out-of-order criterion.

Using the example of FIG. 3, this can be implemented in a similar manner as 326-328 (subdivide chunks into segments (e.g., 16 MB into 16x1 MB IOVECTORS) 326; and IOVECTOR: array of buffers for scatter-gather I/O to storage 328).

Together, operations 804-806 can comprise storing at least a portion of the respective results in a temporary buffer before the storing of the respective results of the respective asynchronous remote direct memory access read operations into the respective buffers of the array of buffers, based on the at least the portion of the respective results satisfying an out-of-order criterion.

After operation 806, process flow 800 moves to 808, where process flow 800 ends.

FIG. 9 illustrates another example process flow 900 that can facilitate RDMA single-signal transfer with parallel asynchronous chunking, in accordance with an embodiment of this disclosure. In some examples, one or more embodiments of process flow 900 can be implemented by RDMA single-signal transfer with parallel asynchronous chunking component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 1000 of FIG. 10.

In some examples, process flow 900 can be used to implement operation 706 of FIG. 7.

Process flow 900 begins with 902, and moves to operation 904.

Operation 904 depicts subdividing the respective results into respective segments. Using the example of FIG. 3, this can be implemented in a similar manner as 326 (subdivide chunks into segments (e.g., 16 MB into 16x1 MB IOVECTORS) 326).

After operation 904, process flow 900 moves to operation 906.

Operation 906 depicts storing the respective segments into the respective buffers of the array of buffers. Continuing with the example of FIG. 3, this can be implemented in a similar manner as 328 (IOVECTOR: array of buffers for scatter-gather I/O to storage 328).

Together, operations 904-906 can comprise subdividing the respective results into respective segments, wherein the storing of the respective results of the respective asynchronous remote direct memory access read operations into the respective buffers of the array of buffers comprises storing the respective segments into the respective buffers.

After operation 906, process flow 900 moves to 908, where process flow 900 ends.

FIG. 10 illustrates another example process flow 1000 that can facilitate RDMA single-signal transfer with parallel asynchronous chunking, in accordance with an embodiment of this disclosure. In some examples, one or more embodiments of process flow 1000 can be implemented by RDMA single-signal transfer with parallel asynchronous chunking component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts, based on receiving a PUT object operation instruction from an object storage client that indicates an object, wherein the object storage client stores the object in a memory of the object storage client, performing respective asynchronous remote direct memory access read operations on respective chunks of the memory of the object storage client. In some examples, operation 1004 can be implemented in a similar manner as operations 504-506 of FIG. 5.

In some examples, the memory of the object storage client comprises a graphics processing unit memory.

In some examples, the PUT object operation instruction adheres to a representational state transfer application programming interface. That is, the present techniques can incorporate a RESTful API for transferring object data, and that can use HTTP and HTTPS protocols for data transfers.

In some examples, the performing of the respective asynchronous remote direct memory access read operations on the respective chunks of the memory of the object storage client occurs independently of a first operating system of the system, and independently of a second operating system of the object storage client. That is, RDMA can provide for direct memory access from the memory of one computer into that of another without involving either computer's operating system.

After operation 1004, process flow 1000 moves to operation 1006.

Operation 1006 depicts storing respective results of the respective asynchronous remote direct memory access read operations into respective buffers of an array of buffers. In some examples, operation 1006 can be implemented in a similar manner as operation 508 of FIG. 5.

In some examples, a backend storage system comprises the respective buffers, and the storing of the respective results of the respective asynchronous remote direct memory access read operations into the respective buffers of the array of buffers comprises sending, to the backend storage system, respective IOVECTOR write instructions. This can be implemented in a similar manner as operation 410 of FIG. 4.

After operation 1006, process flow 1000 moves to 1008, where process flow 1000 ends.

### EXAMPLE OPERATING ENVIRONMENT

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of object storage client 102, object storage server 106, and/or storage backend 110.

In some examples, computing environment 1100 can implement one or more embodiments of the process flows of FIGS. 4-10 to facilitate RDMA single-signal transfer with parallel asynchronous chunking.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips…), optical discs (e.g., CD, DVD…), smart cards, and flash memory devices (e.g., card, stick, key drive…). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a PUT object operation instruction from an object storage client that indicates an object, wherein the object storage client stores the object in a memory of the object storage client;
based on the receiving of the PUT object operation instruction, performing respective asynchronous remote direct memory access read operations on respective chunks of the memory of the object storage client; and
storing respective results of the respective asynchronous remote direct memory access read operations into respective buffers of an array of buffers.

2. The system of claim 1, wherein the PUT object operation instruction identifies an object storage bucket of the system in which to store the object.

3. The system of claim 1, wherein the PUT object operation instruction identifies an address of the memory and a size of the object.

4. The system of claim 3, wherein an x-rdma-info header of the PUT object operation instruction identifies the address of the memory and the size of the object.

5. The system of claim 1, wherein the PUT object operation instruction is received according to a hypertext transfer protocol.

6. The system of claim 1, wherein the PUT object operation instruction identifies a content length associated with the PUT object operation instruction as being equal to zero.

7. The system of claim 1, wherein the operations further comprise:
determining a number of the respective asynchronous remote direct memory access read operations based on a size of the object indicated in the PUT object operation instruction.

8. The system of claim 7, wherein the number is a first number, wherein the first number of the respective asynchronous remote direct memory access read operations is less than a second number of the respective chunks, and wherein the operations further comprise:
performing multiple waves of the respective asynchronous remote direct memory access read operations.

9. A method, comprising:
based on receiving a PUT object operation instruction from an object storage client that indicates an object, wherein the object storage client stores the object in a memory of the object storage client, performing, by a system comprising at least one processor, respective asynchronous remote direct memory access read operations on respective chunks of the memory of the object storage client; and
storing, by the system, respective results of the respective asynchronous remote direct memory access read operations into respective buffers of an array of buffers.

10. The method of claim 9, further comprising:
processing, by the system, the respective chunks asynchronously.

11. The method of claim 10, further comprising:
monitoring, by the system, respective completion statuses of the respective asynchronous remote direct memory access read operations with respective threads.

12. The method of claim 9, wherein the storing of the respective results of the respective asynchronous remote direct memory access read operations into respective buffers of the array of buffers comprises:
storing at least a portion of the respective results in a temporary buffer before the storing of the respective results of the respective asynchronous remote direct memory access read operations into the respective buffers of the array of buffers, based on the at least the portion of the respective results satisfying an out-of-order criterion.

13. The method of claim 9, further comprising:
subdividing, by the system, the respective results into respective segments, wherein the storing of the respective results of the respective asynchronous remote direct memory access read operations into the respective buffers of the array of buffers comprises storing the respective segments into the respective buffers.

14. The method of claim 9, further comprising:
sending, by the system, the object storage client an indication that the PUT object operation instruction succeeded after the storing of the respective results of the respective asynchronous remote direct memory access read operations into the respective buffers of the array of buffers.

15. The method of claim 14, wherein the indication comprises a hypertext transfer protocol message that comprises a status code that indicates that the PUT object operation instruction was completed successfully.

16. A non-transitory computer-readable medium comprising instructions that, in response to execution, cause a system comprising at least one processor to perform operations, comprising:
based on receiving a PUT object operation instruction from an object storage client that indicates an object, wherein the object storage client stores the object in a memory of the object storage client, performing respective asynchronous remote direct memory access read operations on respective chunks of the memory of the object storage client; and
storing respective results of the respective asynchronous remote direct memory access read operations into respective buffers of an array of buffers.

17. The non-transitory computer-readable medium of claim 16, wherein a backend storage system comprises the respective buffers, and wherein the storing of the respective results of the respective asynchronous remote direct memory access read operations into the respective buffers of the array of buffers comprises:
sending, to the backend storage system, respective IOVECTOR write instructions.

18. The non-transitory computer-readable medium of claim 16, wherein the memory of the object storage client comprises a graphics processing unit memory.

19. The non-transitory computer-readable medium of claim 16, wherein the PUT object operation instruction adheres to a representational state transfer application programming interface.

20. The non-transitory computer-readable medium of claim 16, wherein the performing of the respective asynchronous remote direct memory access read operations on the respective chunks of the memory of the object storage client occurs independently of a first operating system of the system, and independently of a second operating system of the object storage client.
